(19) United States
(12) Patent Application Publication
(10) Pub. No.: US 2024/0062014 A1
(43) Pub. Date: Feb. 22, 2024

(54) GENERATING CANONICAL FORMS FOR TASK-ORIENTED DIALOGUE IN CONVERSATIONAL AI SYSTEMS AND APPLICATIONS

(71) Applicant: NVIDIA Corporation, Santa Clara, CA (US)

(72) Inventors: Makesh Narsimhan Sreedhar, Madison, WI (US); Christopher Parisien, Toronto (CA)

(21) Appl. No.: 17/889,124

(22) Filed: Aug. 16, 2022

(51) Int. Cl. G06F 40/30; G10L 15/22

(52) U.S. Cl. CPC G06F 40/30; G10L 15/22

(57) ABSTRACT

In various examples, techniques for training and using a task-oriented dialogue system are described. Systems and methods are disclosed for determining, using a prompt model(s) and based at least in part on text data, prompt data representing one or more prompts. Additionally, systems and method are disclosed for determining, using a language model(s) and based at least in part on the text data and the prompt data, a canonical form associated with the text data. In some examples, the prompt model(s) is trained to generate the prompt data that causes the language model(s) to output the canonical form. Systems and method are further disclosed for using the canonical form to determine at least an intent associated with the text data. A dialogue manager may then use the intent to perform one or more actions associated with the text data.

### BACKGROUND

Task-oriented dialogue systems are used in many different applications, such as to schedule travel plans (e.g., booking arrangements for transportation and accommodations etc.), plan activities (e.g., making reservations, etc.), communicate with others (e.g., make phone calls, start video conferences, etc.), shop for items (e.g., purchase items from online marketplaces, etc.), and/or so forth. Some task-oriented dialogue systems operate by receiving text—such as text including one or more letters, words, numbers, and/or symbols—that is generated using an input device and/or generated as a transcript of spoken language. In some circumstances, the text may indicate a request to perform a task, such as to schedule a plane flight from an origination location to a destination location. The task-oriented dialogue systems then process the text using a large language model that is configured to output data (e.g., a canonical representation) that a dialogue manger is able to interpret. For instance, the dialogue manager may process the data in order to determine one or more actions for performing the requested task.

Because these task-oriented dialogue systems have such a wide range of applications and domains, creating conversational models may be challenging for developers. For instance, for existing task-oriented dialogue systems, such as DialogFlow and RASA, developers must define intents (e.g., actions) and slots (e.g., parameters) that the task-oriented dialogue systems will accept at each point in the conversational flow. However, distilling the conversational design into discrete intents and slots is often unintuitive for developers and may only express limited meaning to utterances. Moreover, these task-oriented dialogue systems may require either the creation of detailed rule-based grammar or a collection of an extensive dataset (e.g., thousands of user utterances) to train the models. As a result, it is often difficult for developers to easily or efficiently create high-quality, user-friendly task-oriented conversational interfaces.

Some solutions attempt to simplify the process for developers to train the task-oriented dialogue systems by requesting only a small amount of example utterances, such as five to ten utterances per intent. This small amount of example utterances is then used to fine-tune the models of the task-oriented dialogue systems for specific intents. However, while these proposed solutions make it easier for the developers, the proposed solutions generally do not produce high-quality models. For example, if these task-oriented dialogue systems receive text associated with a novel intent for which the models were not trained, the task-oriented dialogue systems may be unable to process the text in order to identify the novel intent. As another example, if these task-oriented dialogue systems receive text associated with a trained intent, but the text represents an utterance that the task-oriented dialogue systems did not receive during training for the intent, which can be quite likely since the task-oriented dialogue systems may be trained using only a handful of utterances—the task-oriented dialogue systems may again be unable to process the text in order to identify the intent.

### SUMMARY

Embodiments of the present disclosure relate to techniques for training and deploying task-oriented dialogue systems. Systems and methods are disclosed that, in some embodiments, use a language model(s) to translate text into a canonical form, where the canonical form may include a constrained semantic representation of the natural language of the text. For instance, to translate the text, the systems and methods may include a prompt model(s) that initially processes the text in order to generate a prompt(s) (e.g., a learned virtual prompt(s), a virtual prompt token(s), etc.). The systems and methods then input both the text and the prompt(s) into a language model(s), such as a large language model(s), that is configured to process the text along with the prompt(s) in order to generate and output the canonical form associated with the text. In some embodiments, and as described herein, the systems and methods are trained to output generalized canonical forms for various intents. The systems and methods, in some embodiments, may then provide at least the canonical form and/or a parameter(s) for a slot(s) to a dialogue manager that is able to process the canonical form and/or the slot(s) and determine one or more actions for performing the requested task(s). As such, and in some embodiments, the prompt model(s) is trained to generate a prompt(s) that causes the language model(s) to output a specific canonical form that the dialogue manager is able to interpret to perform the task(s).

In contrast to conventional systems, such as those described above that require classifications with discrete intent labels, one or more embodiments of the present disclosure are able to translate text into a generalized canonical form that the dialogue manager is able to interpret. For instance, since the canonical form represents a sequence of text (e.g., a sequence of words), even if one or more terms in the canonical form were not presented during training, the current systems may still be able to interpret novel (e.g., previously unencountered) intents by generalizing in a manner consistent with the training of the model(s). For example, if the current systems were trained for a specific intent, such as scheduling plane reservations, the current systems may still be able to interpret text that requests a novel intent, such as scheduling a cruise reservation. This is because the current systems, in some embodiments, may still output a canonical form, such as “booking a cruise reservation,” which is similar to a canonical form for which the current systems were trained, such as “booking a plane reservation.”

Additionally, in contrast to conventional systems that train a large language model to generate canonical forms, the current systems train the prompt model(s) for an intent(s) and/or a task(s) without the need to also train the language model(s) that generates the canonical forms. In some examples, the prompt model(s) may be much smaller than the language model(s). For example, the prompt model(s) may include a first number of parameters, such as one million parameters (and/or any other number of parameters), while the language model(s) includes a second, larger number of parameters, such as one billion parameters (and/or any other number of parameters). As such, by training the prompt model(s) rather than the language model(s), less training data, compute resources, and time may be used (e.g., five to ten utterances per intent) for training while still providing high-quality results.

### BRIEF DESCRIPTION OF THE DRAWINGS

The present systems and methods for training and deploying task-oriented dialogue managers are described in detail below with reference to the attached drawing figures, wherein:

FIG. 1 illustrates an example of a language system, in accordance with some embodiments of the present disclosure;

FIGS. 2A-2B illustrate examples of a language system outputting canonical forms with a generalized structure, in accordance with some embodiments of the present disclosure;

FIG. 3 illustrates using vectors to determine a canonical form associated with text, in accordance with some embodiments of the present disclosure;

FIG. 4 illustrates a dialogue manager using a canonical form to determine an intent associated with text, in accordance with some embodiments of the present disclosure;

FIG. 5 is a data flow diagram illustrating a process for training a language system, in accordance with some embodiments of the present disclosure;

FIG. 6 illustrates examples of training data for training a prompt model(s), in accordance with some embodiments of the present disclosure;

FIG. 7 is a flow diagram showing a method for using a language system, in accordance with some embodiments of the present disclosure;

FIG. 8 is a flow diagram showing a method for training a language system, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to techniques for training and using task-oriented dialogue systems. For instance, a system(s) may receive and/or generate text data representing one or more letters, words, numbers, symbols, and/or the like. In some examples, the text data may represent one or more words input by a user into the system(s) and/or another computing device. In some examples, the text data may represent one or more words associated with a transcript and/or diarization of a spoken utterance from the user. In either of the examples, the text data may represent a task being requested by the user, such as to book a plane flight from an origination location to a destination location. The system(s) may then process the text data in order to identify an intent associated with the requested task and information for a slot(s) of the intent. As described herein, an intent may include, but is not limited to, booking a reservation (e.g., booking a plane flight, booking a hotel, booking a dinner reservation, etc.), scheduling an event (e.g., scheduling a birthday party, scheduling a sporting match, etc.), starting a communication (making a phone call, starting a video conference, etc.), creating a list (e.g., creating a shopping list, creating a to-do list, etc.), acquiring an item and/or service, and/or any other intent. Additionally, the slot(s) may provide additional information (e.g., parameters) for performing the intent. For example, if the text data represents a user utterance such as “Schedule a flight from Spokane to Atlanta on July 25,” then the intent may include “booking a flight” and the slots may include an “origination location” of Spokane, a “destination location” of Atlanta, and a “date” of July 25.

To process the text data, the system(s) may include a prompt model(s) that is configured to process the text data in order to generate prompt data associated with the text data. The prompt data may represent one or more virtual prompts and/or one or more prompt tokens. For example, the prompt data may represent one or more vectors, where each vector represents a respective word(s) identified by the prompt model(s) when processing the text data. The system(s) may also include a language model(s), such as a large language model(s), that is configured to process the text data along with the prompt data in order to generate a canonical form associated with the text. As described herein, the canonical form may include a constrained semantic representation of the natural language of the text. For instance, and using the example above, the canonical form of the text may include a representation such as “booking a plane flight.” In some examples, the canonical form is further extended with conditional statements, nested semantics, and/or other complex representations. The system may then input this canonical form and/or a parameter(s) associated with a slot(s) (and, in some examples, additional data) into a dialogue manager that is able to process the canonical form and/or the parameter(s) and determine one or more actions for performing the requested task.

In some examples, the system is trained such that the weights of the parameters of the prompt model(s) are updated without updating the weights of the parameters of the language model(s). For instance, training data may include text data representing text (e.g., a sequence(s) of letters, words, numbers, and/or symbols) along with ground truth data representing a canonical form(s) associated with the text. To train the system, the system may process the text data using one or more of the processes described herein in order to output a canonical form(s) associated with the text. A training engine may then determine one or more errors based on a difference(s) between the canonical form(s) represented by the ground truth data and the canonical form(s) output by the system. Additionally, the system may update the weight(s) and/or bias(es) of the parameter(s) of the prompt model(s) based on the error(s). By training the system using such processes, the prompt model(s) may be configured to generate prompt data that causes the language model(s) to output a specific canonical form(s) that the dialogue manager is able to quickly and accurately interpret.

The systems and methods described herein may be used for a variety of purposes, by way of example and without limitation, in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, real-time streaming, virtual reality, mixed reality, or augmented reality, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-cabin, infotainment, and/or entertainment system of an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

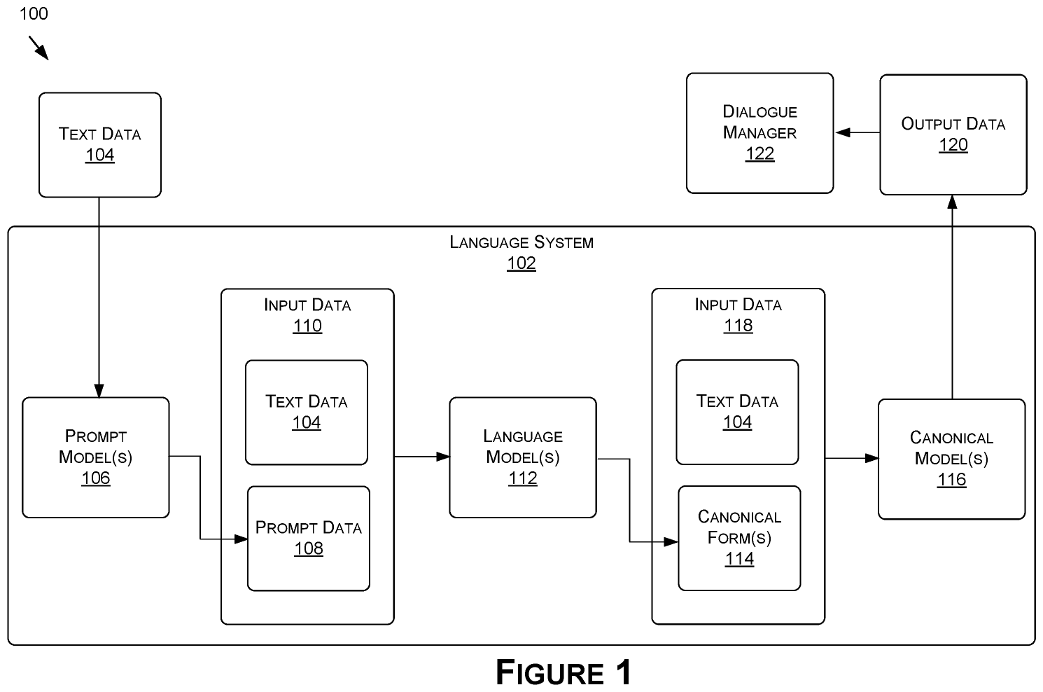

FIG. 1 illustrates an example of a language system 102, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include the language system 102 receiving text data 104. As described herein, in some examples, the text data 104 may represent one or more letters, words, symbols, and/or numbers input by a user into a device (e.g., a computing device 900) and/or may represent one or more letters, words, symbols, and/or numbers from a transcript or diarization generated based on a spoken utterance by the user. For example, the user may provide audible input (e.g., the user utterance) into a device, such as a mobile phone, a table, a computer, a television, a voice assistant, a kiosk, and/or any other type of device (e.g., the computing device 900). The audible input may then undergo one or more processing or pre-processing steps, such as through one or more natural language processing (NLP) systems (which may be included as part of the language system 102 or separate from the language system 102) that evaluate the audible input in order to extract one or more features from the audible input. Furthermore, in some examples, an input processor may include a text processing system for preprocessing (e.g., tokenization, removal of punctuation, removal of stop words, stemming, lemmatization, text normalization, inverse text normalization, etc.), feature extraction, and/or the like. The device may then generate the transcript or diarization that represents the audible input, where the text data 104 represents the transcript or diarization.

The process 100 may include a prompt model(s) 106 that processes the text data 104 in order to generate prompt data 108. As described herein, in some examples, the prompt data 108 may represent one or more virtual prompts and/or one or more prompt tokens. For a first example, the prompt data 108 may represent one or more vectors, where each vector represents a word(s) identified by the prompt model(s) 106 when processing the text data 104. For a second example, the prompt data 108 may again represent one or more vectors, but where one or more of the vector(s) do not represent an actual word(s). As will be described in more detail below, the prompt model(s) 106 may be trained in order to output specific prompt data 108 based on the one or more words represented by the text data 104. For example, the prompt model(s) 106 may be trained to output a specific vector(s) (or a vector within a threshold similarity to the specific vector(s)) each time the prompt model(s) 106 receives a specific or similar to a specific set of one or more words.

In some examples, the prompt model(s) 106 may be configured to generate an output data that may be used—with or without pre-processing—as input data 110 for a language model(s) 112 of the language system 102. For example, the input data 110 may include both the original text data 104 input into the prompt model(s) 106 and the prompt data 108. In other examples, the prompt model(s) 106 may be configured to output the prompt data 108, where the language system 102 then generates the input data 110 by at least associating the text data 104 with the prompt data 108. In some examples, and as also illustrated in the example of FIG. 1, both the text data 104 and the prompt data 108 are provided as part of the input data 110 for the language model(s) 112. However, in other examples, the prompt data 108 may be provided to the language model(s) 112 without the text data 104.

The process 100 may include the language model(s) 112 processing the input data 110 and, based on the processing, outputting a canonical form 114 associated with the text data 104. In some examples, the language model(s) 112 may include a large language model(s), such as a frozen large language model(s). For instance, the language model(s) 112 may be trained on a large amount of data. In some examples, the language model(s) 112 may include any type of language model(s), such as a generative language model(s) (e.g., a Generative Pretrained Transformer (GPT), etc.), a representation language model(s) (e.g., Bidirectional Encoder Representations from Transformers (BERT), etc.), and/or the like. As described herein, the canonical form 114 may include a constrained semantic representation of the natural language of the text represented by the text data 104. In some examples, and as discussed in more detail with regard to the training of the language system 102, the language system 102 may be trained to output canonical forms 114 that include a generic structure.

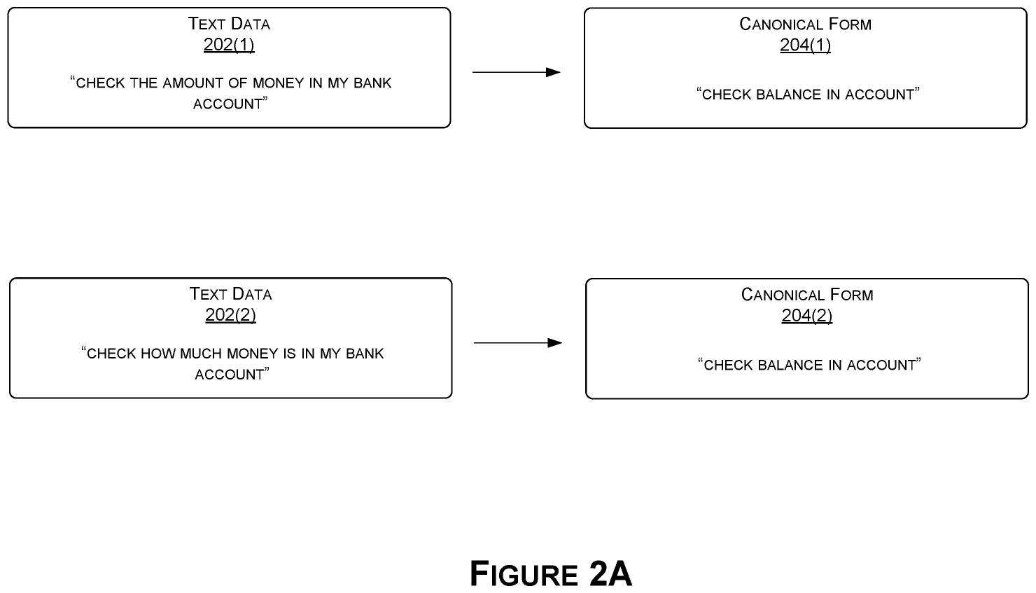

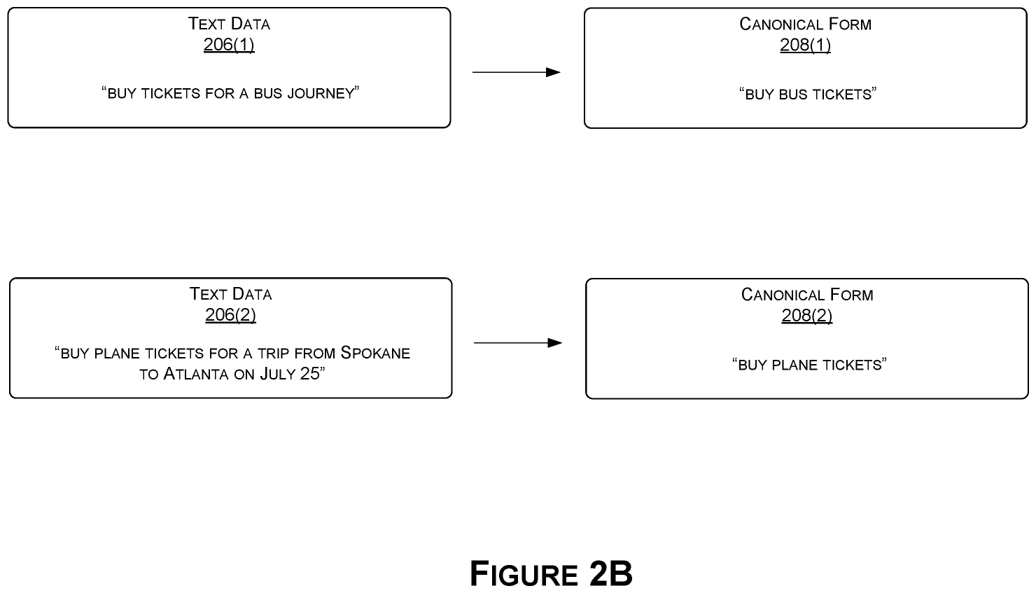

For instance, FIG. 2A illustrates a first example of the language system 102 outputting canonical forms 114 with similar structure, in accordance with some embodiments of the present disclosure. As shown by the example of FIG. 2A, if first text data 202(1) represents a first user utterance “check the amount of money in my bank account,” then a canonical form 204(1) associated with the first text data 202(1) may include “check balance in account.” Additionally, if second text data 202(2) represents a second user utterance “check how much money is in my bank account,” then a canonical form 204(2) associated with the second text data 202(1) may also include “check balance in account.” As such, even though the words within the second text data 202(2) differ slightly from the words within the first text data 202(1), the canonical form 204(1) for the first text data 202(1) matches the canonical form 204(2) for the second text data 202(2). This may be because, in some examples, the language system 102 is trained to output the canonical forms 204(1)-(2) using a similar structure.

Additionally, FIG. 2B illustrates a second example of the language system 102 outputting canonical forms 114 with similar structure, in accordance with some embodiments of the present disclosure. As shown by the example of FIG. 2B, if first text data 206(1) represents a first user utterance “buy tickets for a bus journey,” then a canonical form 208(1) associated with the first text data 206(1) may include “buy bus tickets.” Additionally, if second text data 206(2) represents a second user utterance “buy plane ticket for a trip from Spokane to Atlanta on July 25,” then a canonical form 208(2) associated with the second text data 206(2) may include “buy plane tickets.” As such, even though the first text data 206(1) is associated with the first utterance about buying a bus ticket (e.g., a first intent) and the second text data 206(2) is associated with the second utterance for buying a plane ticket (e.g., a second, different intent), the canonical forms 208(1)-(2) include a similar structure. More specifically, both canonical forms 208(1)-(2) start with the word “buy,” end with the word “ticket,” and have a middle word representing the type of ticket (e.g., based on the intent). Similar structures may be used for other canonical forms 114, such as canonical forms 114 that are associated with similar intents (e.g., booking and/or scheduling an event).

For example, a canonical form 114 associated with an intent for booking a cruise may include “buy cruise tickets,” a canonical form 114 associated with an intent for buying baseball tickets may include “buy baseball tickets,” a canonical form 114 associated with an intent for buying movie tickets may include “buy movie tickets,” a canonical form 114 associated with an intent for buying carnival tickets may include “buy carnival tickets,” and/or so forth. In some examples, by using canonical forms 114 with similar structure, the language system 102 is able to provide good results even for intents that the language system 102 was not specifically trained to process (e.g., intents that are new or novel to the language system 102).

For example, and using the example of FIG. 2B, the language system 102 may be trained for a first intent “buy plane tickets,” but not a second intent “buy bus tickets.” As such, the language model(s) 102 may be trained to output the canonical form 208(2) “buy plane tickets” when receiving the text data 206(2) representing the utterance “buy plane tickets for a trip from Spokane to Atlanta on July 25” (and/or some other utterance associated with booking plane tickets). If the language model(s) 102 then receives the text data 206(2) representing the utterance “buy tickets for a bus journey,” the language model(s) 102 may still be able to generate the canonical form 208(1) “buy bus tickets” even though the language model(s) 102 was not trained for the second intent. This is because the structure of the canonical form 208(1) is similar to the structure of the canonical form 208(2), except for the ticket type in the middle of the representation. However, the language model(s) 102 may still be able to determine that ticket type by processing the text data 206(1) and/or the prompt data 108 that the prompt model(s) 106 generates for the text data 206(1).

As described herein, in some examples, the language system 102 (e.g., the language model(s) 112) may be configured to extend the canonical form(s) 114 with a conditional statement(s), a nested semantic(s), and/or another more complex representation(s). For instance, and using the example of FIG. 2B, the language system 102 (e.g., the language model(s) 112) may extend the canonical form 208(2) to include one or more words, such as “for a trip,” “roundtrip,” “one way trip,” and/or so forth. In some examples, the language model(s) 102 learns the conditional statement(s), the nested semantic(s), and/or the other complex representation(s) during training.

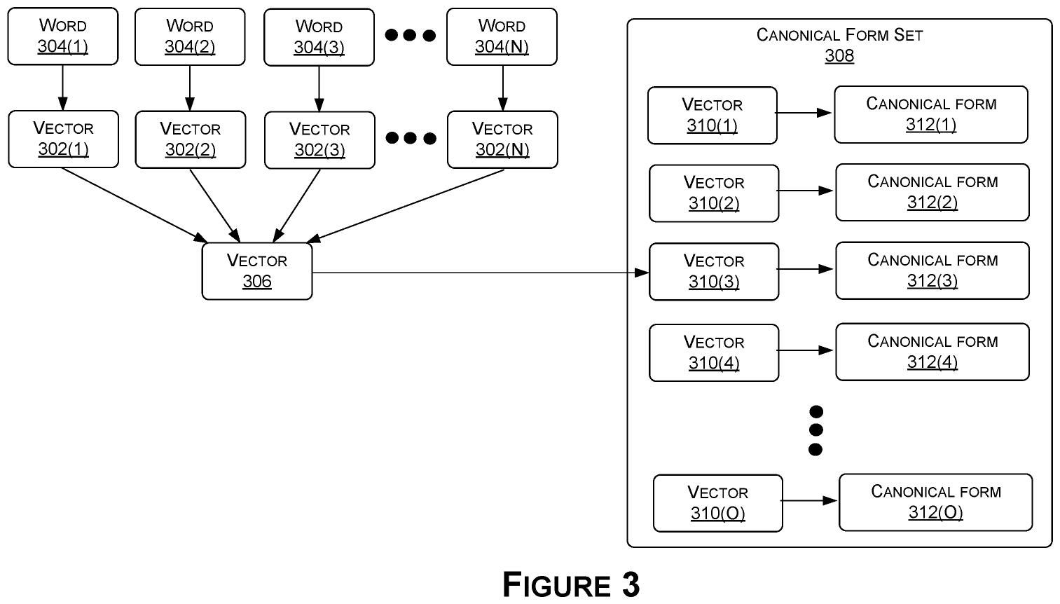

In some examples, the language system 102 (e.g., the language model(s) 112 and/or another component of the language system 102) may use the output from the language model(s) 112 to determine a final canonical form for the text data 104. For instance, FIG. 3 illustrates using vectors to determine a canonical form associated with text, in accordance with some embodiments of the present disclosure. As shown, the language system 102 (e.g., the language model(s) 112) may determine vectors 302(1)-(N) (also referred to singularly as “vector 302” or in plural as “vectors 302”) for words 304(1)-(N) (also referred to singularly as “word 304” or in plural as “words 304”). In some examples, the language model(s) 112 may initially determine and/or output the vectors 302 based on processing the input data 110, where each vector 302 is associated with a word(s) 304. In some examples, the language model(s) 112 may initially generate and/or output the word(s) 304 (e.g., an initial canonical form) based on processing the input data 110. In such examples, the language system 102 (e.g., the language model(s) 112) may use a mapping to determine the vectors 302 for the word(s) 304.

In either example, the language system 102 (e.g., the language model(s) 112) may then use the vectors 302 to determine a final canonical form. For example, the language system 102 (e.g., the language model(s) 112) may use the vectors 302 to determine a final vector 306 associated with the word(s) 304. In some examples, the language system 102 (e.g., the language model(s) 112) may determine the final vector 306 by taking the average of the vectors 302 (e.g., adding the vectors 302 and then dividing by the number of vectors 302) In some examples, the language system 102 (e.g., the language model(s) 112) may determine the final vector 306 using one or more additional and/or alternative techniques, such as the mean of the vectors 302, the mode of the vectors 302, the median of the vectors 302, the sum of the vectors 302, and/or so forth. In any of the examples, the final vector 306 may correspond to a sentence vector that represents the meaning of the sentence associated with the word(s) 304.

The language system 102 (e.g., the language model(s) 112) may then use a canonical form set 308 to determine the final canonical form. As shown by the example of FIG. 3, the canonical form set 308 associates (e.g., maps) vectors 310(1)-(O) (also referred to singularly as “vector 310” or in plural as “vectors 310”) with canonical forms 312(1)-(O) (also referred to singularly as “canonical form 312” or in plural as “canonical forms 312”). To use the canonical form set 308, the language system 102 (e.g., the language model(s) 112) may compare the final vector 306 to the vectors 310 in order to identify a vector 310 that matches the final vector 306 and/or a vector 310 that is the closest match to the final vector 306. For instance, and in the example of FIG. 3, the language system 102 (e.g., the language model(s) 112) may determine that the vector 310(3) is the closest match vector 310 to the final vector 306. The language system 102 (e.g., the language model(s) 112) may then use the vector 310(3) to determine the final canonical form. For example, since the vector 310(3) is associated with (e.g., mapped to) the canonical form 312(3), then the language system 102 (e.g., the language model(s) 112) may select the canonical form 312(3).

In some examples, by using such a process to identify the final canonical form 312(3), the language system 102 (e.g., the language model(s) 112) is able to output the words 304 and/or the vectors 302 in any order and the language system 102 (e.g., the language model(s) 112) is still able to determine the final canonical form 312(3) using the final vector 306. Additionally, in some examples, by using such a process, the language system 102 is able to provide a canonical form(s) for an intent(s) that the language system 102 has not been trained to identify.

For instance, and using the example of FIG. 2B, if the language system 102 was trained to identify an intent associated with the buying plane tickets, but the language system 102 receives the text data 206(1) associated with the request to buy a bus ticket, then the language system 102 may still be able to generate the canonical form 208(1). This is because the language system 102 (e.g., the language model(s) 112) may still output words and/or vectors for the text data 206(1) that are similar to the words and/or vectors that the language system 102 (e.g., the language model(s) 112) would output for the text data 206(2). As such, and using the process of FIG. 3, the language system 102 (e.g., the language model(s) 112) may determine a canonical form for the text data 206(1) that is similar to the canonical form 208(2) for the text data 206(2) (e.g., include at least “buy” and “tickets”). The language system 102 (e.g., the language model(s) 112) may also be configured to extend the canonical form with conditional statements and/or nested semantics in order to generate the canonical form 208(1) for the text data 206(1).

For example, the language system 102 (e.g., the language model(s) 112) may determine that the text data 206(1) represents the word “bus.” As such, the language system 102 (e.g., the language model(s) 112) may generate the canonical form 208(1) by replacing the word “plane” within the canonical form 208(2) that the language system 102 (e.g., the language model(s) 112) selected with the word “bus.” This way, the language system 102 (e.g., the language model(s) 112) is able to use the similar structures for the canonical forms 114 in order to generate canonical forms for intents that the language system 102 (e.g., the language model(s) 112) has not been trained to identify.

While the example of FIG. 3 illustrates a single vector 302 for each word 304, in other examples, each word 304 may be associated with one or more vectors 302. For example, a single word 304 may be associated with two or more vectors 302 that together represent the word 304. Additionally, in some examples, a vector 302 output by the language model(s) 112 may not be associated with an actual word 304—e.g., but instead may be associated with two or more words, or parts of words, such as phonemes or letters.

Additionally, while the example of FIG. 3 describes the language model(s) 112 as determining the final vector 306 associated with the words 304, in other examples, another model(s) may be configured to determine the final vector 306. For example, the words 304 may be input to the other model(s) that is trained to process the words 304 and output the final vector 306 associated with the words 306.

Referring back to FIG. 1, a canonical model(s) 116 may process input data 118, which includes the canonical form 114 and/or the text data 104, and output data 120 for processing by a dialogue manager 122. While the example of FIG. 1 illustrates the canonical model(s) 116 as being separate from the language model(s) 112, in other examples, the canonical model(s) 116 may be part of the language model(s) 112.

To generate the output data 120, the canonical model(1) 116 may initially process the canonical form 114 to determine an intent of the text data 104. The canonical model(s) 116 and/or the language model(s) 112 may also determine one or more parameters for one or more slots associated with the intent. In some examples, the canonical model(s) 116 and/or the language model(s) 112 may determine the parameter(s) based on further analyzing the canonical form 114, the text data 104, and/or the prompt data 108. In some examples, the canonical model(s) 116 may determine the parameter(s) based on receiving the parameter(s) from the language model(s) 112 (e.g., such as when the language model(s) 112 determine the parameter(s) using the text data 104 and/or the prompt data 108). As described in more detail here, the language model(s) 112 and/or the canonical model(s) 116 may determine the parameter(s) for the slot(s) using similar processes that the language model(s) 112 uses to determine the canonical form(s) 114.

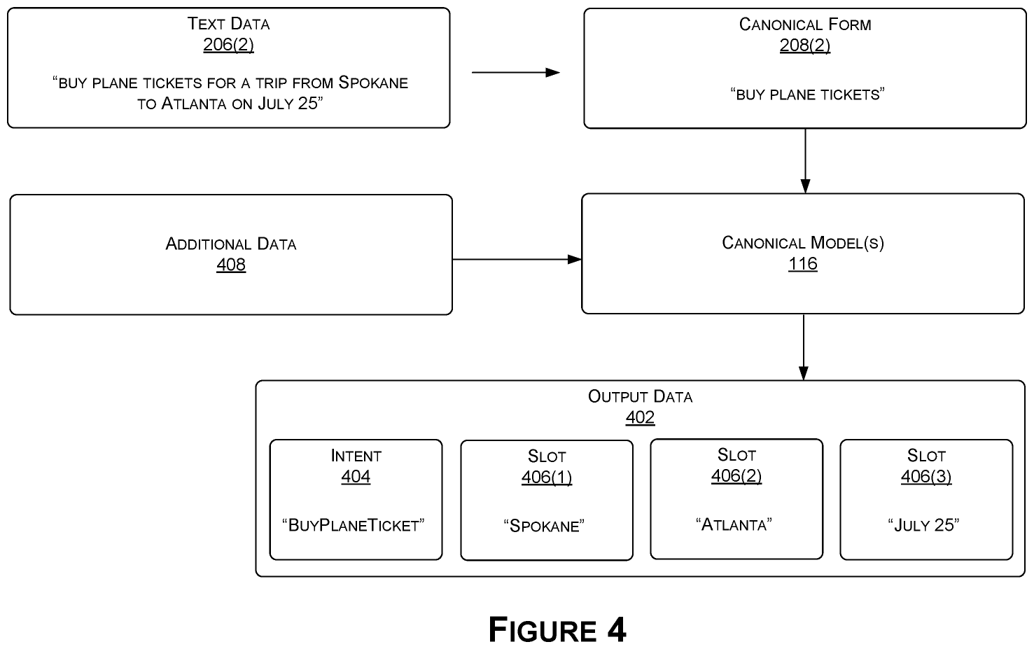

For instance, FIG. 4 illustrates the canonical model(s) 116 using the canonical form 208(2) (and additional data) to determine an intent and slots associated with the intent, in accordance with some embodiments of the present disclosure. As shown, the canonical model(s) 116 may receive, as input, the canonical form 208(2) “buy plane tickets” that is associated with the text data 206(2) “buy plane tickets for a trip from Spokane to Atlanta on July 25.” The canonical model(s) 116 may then process the canonical form 208(2) and output data 402 (which may include, and/or represent, the output data 120″) that includes an intent 404 associated with the text data 206(2). In the example of FIG. 4, the intent 404 includes “BuyPlaneTickets.” However, in other examples, the intent 404 may include one or more words, such as another canonical representation.

In some examples, the canonical model(s) 116 may also determine slots 406(1)-(3) (also referred to singularly as “slot 406” or in plural as “slots 406”) associated with the intent 404. As shown, the first slot 406(1) associated with the intent 404 includes “Spokane,” which may include the origination location of the trip. The second slot 406(2) associated with the intent 404 includes “Atlanta,” which may include the destination location of the trip. Finally, the third slot 406(3) associated with the intent 404 includes “July 25,” which may include the date of the trip. While the example of FIG. 4 illustrates the intent 404 being associated with three slots 406, in other examples, the intent 404 may be associated with any number of slots 406. For example, the intent 404 may be associated with more than the three slots 406, such as a fourth slot associated with a time for the trip. In such an example, since the text data 206(2) did not indicate the time, the canonical model(s) 116 may cause the fourth slot to remain empty (e.g., not provide information for the fourth slot).

In the example of FIG. 4, the canonical model(s) 116 may determine the slots 406 using additional data 408. In some examples, the additional data 408 may include the text data 406(2) and/or the prompt data 108 associated with the text data 406(2). For example, the canonical model(s) 116 may process the text data 206(2) and/or the prompt data 108 in order to determine the information for each of the slots 406. Additionally, or alternatively, in some examples, the additional data 408 may include data received from another component, such as the language model(s) 112. For example, the language model(s) 112 may process the text data 206(2) and/or the prompt data 108 in order to determine the information for each of the slots 406. The language model(s) 112 may then send, to the canonical model(s) 116, the additional data 408 that represents the information for the slots 406. Using the additional data 408, the canonical model(s) 116 may input the information into the correct slots 406.

In some examples, the additional data 408 may indicate the slots 406 that the canonical model(s) 116 and/or the language model(s) 112 are to determine for the intent 404. The slots 406 may include, but are not limited to, one or more required slots 406, one or more optional slots 406, and/or one or more different types of slots. As described herein, a required slot 406 may include a slot 406 for which information is required to perform an action associated with the intent 404 (which is described in more detail with respect to a dialogue manager 120. Additionally, an optional slot 406 may include a slot 406 for which information is optional to perform the action associated with the intent 404. For instance, and using the example above, the slots 406 may include required slots 406 since the dialogue manager 120 is unable to perform the action associated with buying a plane ticket without the origination location, the destination location, and the date. However, an optional slot 406 associated with the intent 404 may include a time of day for the trip. This is because the dialogue manager 120 will still be able to perform the action without the information about the time of day.

In some examples, the language model 112 and/or the canonical model(s) 116 may be trained to use natural language for slots, similar to the canonical form(s) 114. For example, the language model(s) 112 and/or the canonical model(s) 116 may be trained to use the prompt data 108 and the text data 104 to determine the slots 406 associated with the intent 404. In such examples, using the natural language may also improve the accuracy of the language system 102 and/or the canonical model(s) 116, such as when the language system 102 receives text data 104 associated with a novel intent and/or when the language system 102 receives text data 104 associated with a trained intent, but which represents a novel slot(s) for which the language system 102 was not trained.

For a first example, if the language system 102 was trained to identify a first intent, such as “buying plane tickets,” the language system 102 may still receive text data 104 associated with a second, untrained intent, such as “buying train tickets.” Performing the processes described herein, the language system 102 may be able to generate an intent (e.g., which may include a canonical form, such as a canonical form 114) associated with the text data 104, such as “buying a train ticket.” Additionally, the language system 102 may use one or more of the slot(s) associated with the first intent for the second intent. For instance, if the first intent is associated with the slots “origination location,” “destination location,” and “date,” the language system 102 may use similar slots for the second intent. This is because the slots are associated with natural language and may be used by many intents, such as intents that are associated with booking an activity (e.g., booking a plane ticket, booking a cab, booking a train ticket, booking a cruise, etc.).

For a second example, the language system 102 may have been trained to identify first slots for a first intent and second slots for a second intent. For instance, if the first intent is again associated with “booking plane tickets,” then the first slots may include “origination location,” “destination location,” and “date.” Additionally, if the second intent is associated with “booking train tickets,” then the second slots may include “origination location,” “destination location,” “date,” and “time.” As such, if the language system 102 receives text data 104 representing text that includes “buy plane tickets from Spokane to Atlanta on July 25 at 8:00,” the language system 102 may determine the information for the slots associated with the first intent as well as the additional slot associated with the second intent. For instance, the language system 102 may determine information that includes “Spokane” for the origination location, “Atlanta” for the destination location,” “July 25” for the date, and “8:00” for the time.

In some examples, the language system 102 is able to learn this new slot for the first intent since the slots for the intents use natural language. For instance, the language system 102 may be able to process the text data 104 (and/or other data, such as the prompt data 108) to easily identify the “date” represented by the text data 104 (and/or the other data). In other words, the language system 102 may continue to learn new, relevant slots for an intent using or more slots for another intent(s) (e.g., another similar intent(s)).

Referring back to FIG. 1, the process 100 may include the dialogue manager 122 processing the output data 120 in order to perform an action(s) associated with the text data 104. For instance, the dialogue manager 122 may use the intent and/or the slot(s) as represented by the output data 120 to determine the action(s) to perform. In some examples, the action(s) may include a response for a system to take based on the intent and/or the slot(s). For instance, and using the example of FIG. 4, the action may include booking a plane ticket from Spokane to Atlanta on July 25. In some examples, the action(s) may include generating a response to provide to a user. For instance, and again using the example of FIG. 4, if the dialogue manager 122 determines that the time is needed to perform the intent 404, then the dialogue manager 122 may generate a response that includes “What time would you like when booking your trip” for the user.

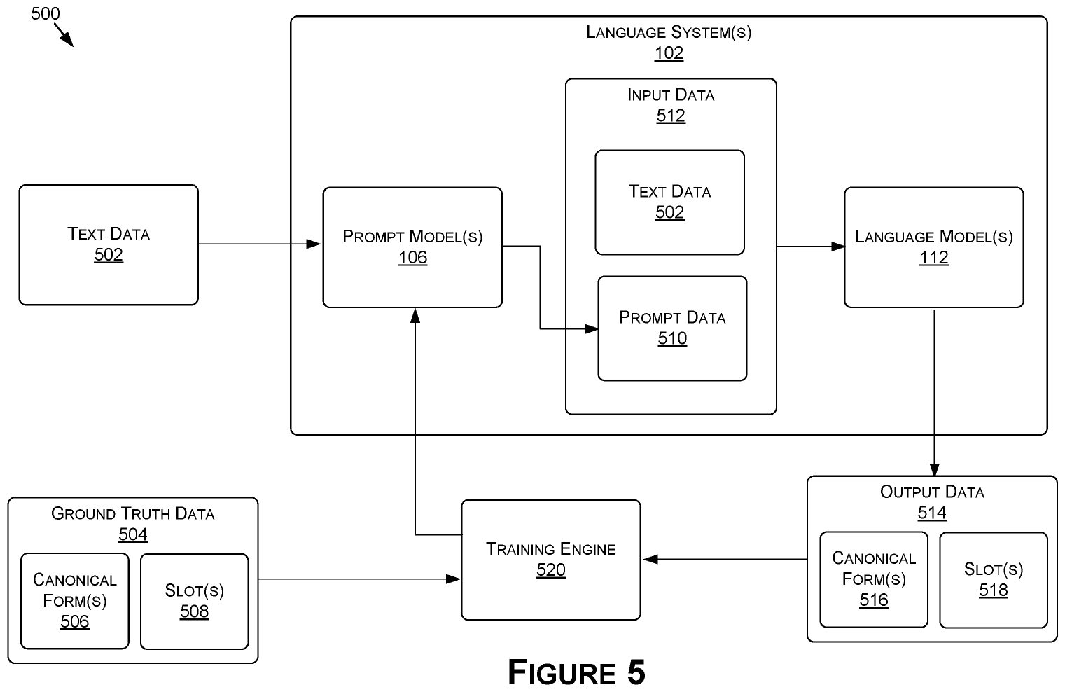

As described herein, the prompt model(s) 106 may be trained to generate prompt data 108 that causes the language model(s) 112 to output a specific canonical form(s) 114. For instance, FIG. 5 is a data flow diagram illustrating a process 500 for training the prompt model(s) 106, in accordance with some embodiments of the present disclosure. In the example of FIG. 5, the canonical model(s) 112 may be included as part of the language model(s) 112.

As shown, the prompt model(s) 106 may be trained using text data 502 (e.g., training text data). The text data 502 used for training may represent text, such as various phrases, sentences, transcripts, and/or other groupings of one or more words, letter, symbols, and/or numbers. The prompt model(s) 106 may also be trained using ground truth data 504 that corresponds to the text data 502. As shown, the ground truth data 504 may include a canonical form(s) 506 and/or a slot(s) 508 for each group of one or more words represented by the text data 502. In some examples, the ground truth data 504 may be synthetically produced (e.g., generated from computer models), real produced (e.g., designed and produced from real-world data), machine-automated, human generated, and/or a combination thereof.

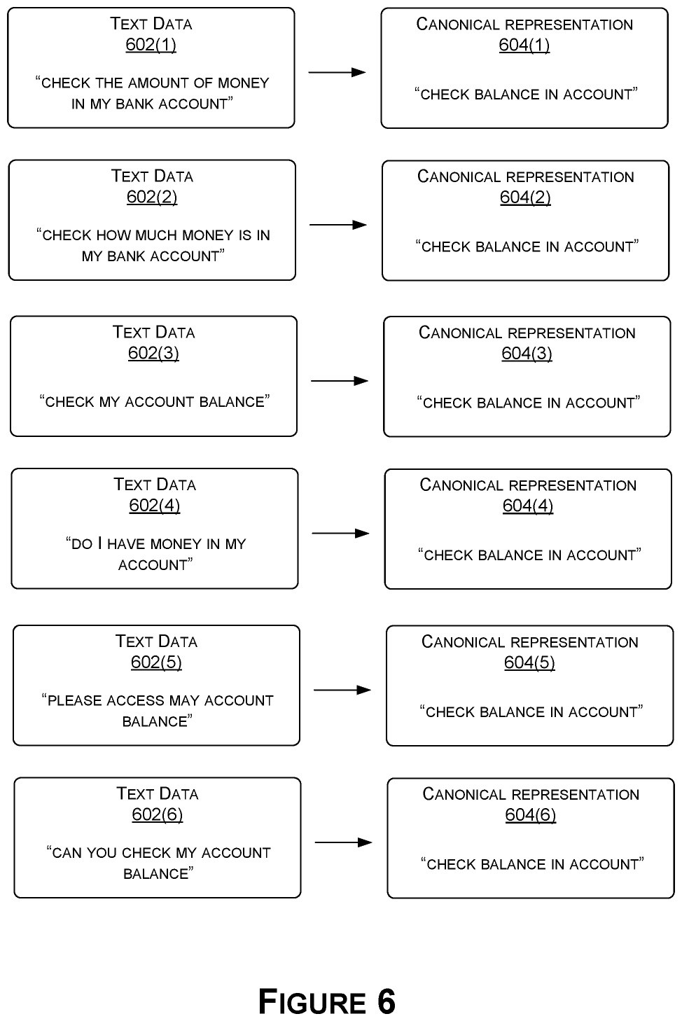

For instance, FIG. 6 illustrates examples of the text data 502 and the ground truth data 504 for training the prompt model(s) 106, in accordance with some embodiments of the present disclosure. In the example of FIG. 6, a developer and/or other type of user may be training the prompt model(s) 106 based on a specific intent, such as “CheckBalance.” As such, text data 602(1)-(6) (which may represent, and/or include, the text data 502) (which may also be referred to “text data 602”) represents transcripts of various user utterances associated with that intent. For example, the first text data 602(1) includes “check the amount of money in my bank account,” the second text data 602(2) includes “check how much money is in my bank account,” the third text data 602(3) includes “check my account balance,” the fourth text data 602(4) includes “do I have money in my account,” the fifth text data 602(5) includes “please check my account balance,” and the sixth text data 602(6) includes “can you check my account balance.”

Each instance of the text data 602 is also associated with a respective canonical form 604(1)-(6) (which may represent, and/or include, the canonical form(s) 506) (which may also be referred to singularly as “canonical form 604” or in plural as “canonical forms 604”). As shown by the example of FIG. 6, each of the canonical forms 604 includes “check balance in account.” In some examples, the canonical form 604 may include “check balance in account” since the dialogue manager 122 is able to accurately identify the intent “CheckBalance” using such a canonical form 604. As such, the developer and/or other user may be training the prompt model(s) 106 to generate specific prompt data 508 that the language model(s) 112 then uses to output the canonical form 604 “check balance in account.”

For instance, and referring back to FIG. 5, the prompt model(s) 106 may perform one or more of the processes described herein to process the text data 502 and output prompt data 510. The language model(s) 112 may then perform one or more of the processes described herein to process input data 512, which includes the text data 502 and the prompt data 510, and output data 514 that represents a canonical form(s) 516 and/or a slot(s) 518 associated with the text data 502. A training engine 520 may use one or more loss functions that measure loss (e.g., error) in the canonical form(s) 516 and/or the slot(s) 518 as compared to the ground truth data 504. In some examples, different outputs 514 may have different loss functions. For example, the canonical form(s) 516 may have a first loss function and the slot(s) 518 may have a second loss function. In some examples, the loss functions may be combined to form a total loss, and the total loss may be used to train (e.g., update the parameters of) the prompt model(s) 106. In any example, backward pass computations may be performed to recursively compute gradients of the loss function(s) with respect to training parameters. In some examples, weight and biases of the prompt model(s) 106 may be used to compute these gradients.

While the examples of FIGS. 5 and 6 describe training the prompt model(s) 106 using six instances of text data 602, in other examples, the prompt model(s) 106 may be trained using any number of instances of text data 602 (e.g., one instance, five instances, ten instances, twenty instances, etc.). Additionally, while the examples of FIGS. 5 and 6 describe training the prompt model(s) 106 in order for the language system 102 to output the same canonical form 604, in other examples, the prompt model(s) 106 may be trained such that the language system 102 outputs one or more other canonical forms 604 that the dialogue manager 116 is also able to process to identify the same intent. For example, the prompt model(s) 106 may be trained such that some text data 602 causes the language system 102 to output another canonical form, which may include “check amount in account.” In such an example, dialogue manager 116 may also process to this other canonical form and identify the intent “CheckBalance.”

Furthermore, while the examples of FIGS. 5 and 6 describe training the prompt model(s) 106 for a single intent, in other examples, similar processes may be used to train the prompt model(s) 106 for one or more other intents. For example, the prompt model(s) 106 may also be trained to cause the language model(s) 112 to output a canonical form(s) associated with a second intent, a canonical form(s) associated with a third intent, a canonical form(s) associated with a fourth intent, and/or so forth.

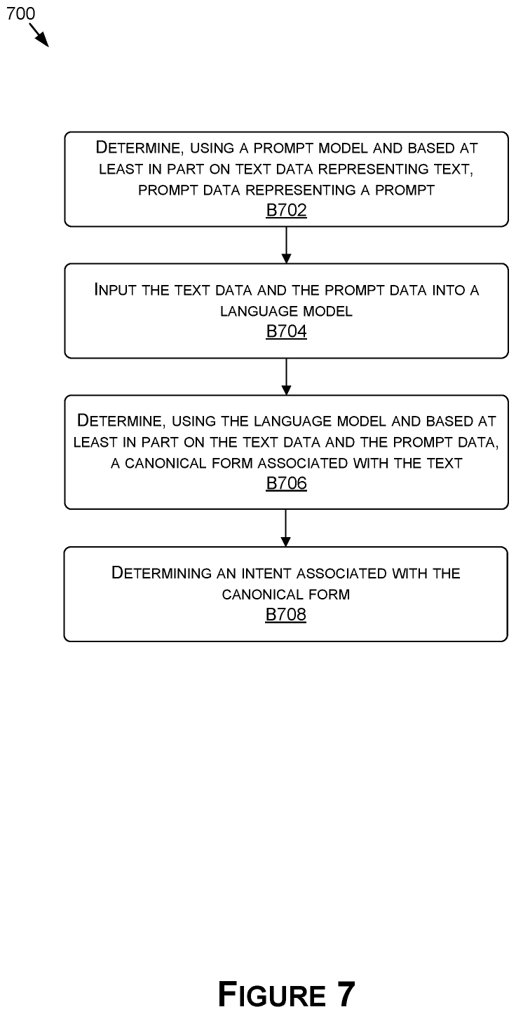

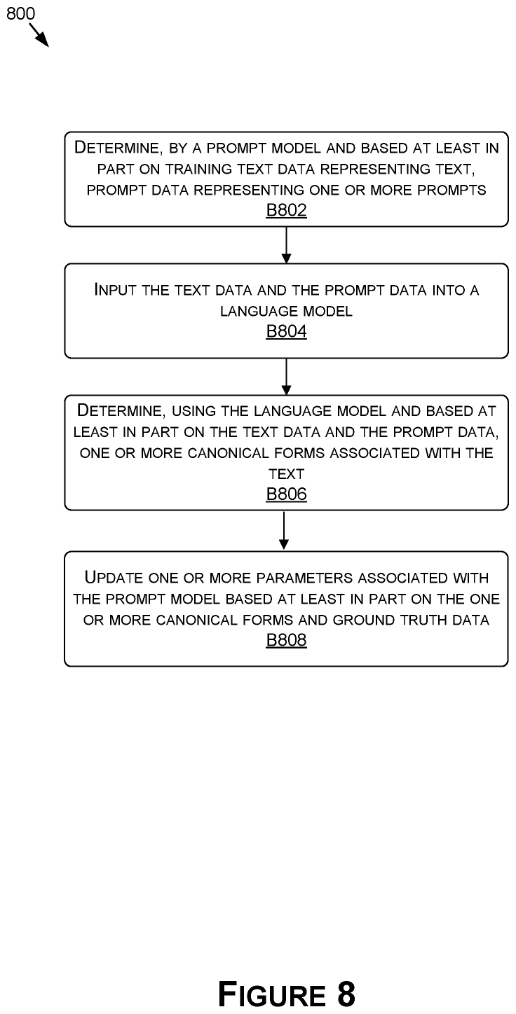

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, methods 700 and 800 are described, by way of example, with respect to the system of FIGS. 1 and 5, respectively. However, the methods 700 and 800 may additionally or alternatively be executed by any one system, or any combination of systems, including, but not limited to, those described herein.

FIG. 7 is a flow diagram showing the method 700 for using the language system 102, in accordance with some embodiment of the present disclosure. The method 700, at block B702, may include determining, using a prompt model(s) and based at least in part on text data representing text, prompt data representing a prompt. For instance, the prompt model(s) 106 of the language system 102 may process the text data 104 in order to output the prompt data 108. As described herein, the text data 104 may represent input text, a transcript of a user utterance, and/or any other type of text. Additionally, in some examples, the prompt data 108 may represent one or more virtual prompts and/or one or more prompt tokens. For example, the prompt data 108 may represent one or more vectors, where each vector represents a word(s) (or portion thereof) identified by the prompt model(s) 106 when processing the text data 104.

The method 700, at block B704, may include inputting the text data and the prompt data into a language model(s). For instance, the text data 104 and the prompt data 108 may be input into the language model(s) 112. In some examples, the prompt model(s) 106 outputs both the text data 104 and the prompt data 108 to the language model(s) 112 of the language system 102. In some examples, the prompt model(s) 106 outputs the prompt data 108 to the language model(s) 112 while the language system 102 also inputs the text data 104 into the language model(s) 112. As described herein, the language model(s) 112 may include a large language model(s).

The method 700, at block B706, may include determining, using the language model(s) and based at least in part on the text data and the prompt data, a canonical form associated with the text. For instance, the language model(s) 112 may process the text data 104 and the prompt data 108 in order to generate an outputin the canonical form 114. As described herein, the canonical form 114 may include a constrained semantic representation of the natural language of the text represented by the text data 104. In some examples, to determine the canonical form 114, a vector(s) is determined for one or more words determined by the language model(s) 112. A final vector is then determined based on the vector(s), where the final vector corresponds to a sentence vector that represents the meaning of the sentence associated with the word(s). The final vector is then used to determine the canonical form 114, such as by finding the closest match to another vector associated with the canonical form 114.

The method 700, at block B708, may include determining an intent associated with the canonical form. For instance, the canonical model(s) 116 may process the canonical form 114 and determine the intent associated with the text data 104. In some examples, the canonical model(s) 116 and/or the language model(s) 112 may further determine information (e.g., one or more parameters) for one or more slots associated with the intent. The language system 102 may then input the intent and the slot(s) into the dialogue manager 122 that process the intent and the slot(s). Based on the processing, the dialogue manager 122 may determine one or more actions to perform.

FIG. 8 is a flow diagram showing the method 800 for training the language system 102, in accordance with some embodiment of the present disclosure. The method 800, at block B802, may include determining, using a prompt model(s) and based at least in part on training text data representing text, prompt data representing one or more prompts. For instance, the prompt model(s) 106 of the language system 102 may process the text data 502 in order to output the prompt data 510. As described herein, the text data 502 may represent text, such as various letters, words, symbols, numbers, phrases, sentences, transcripts, and/or other groupings. In some examples, the text data 502 may include one or more groupings of words associated with a single intent. In some examples, the text data 502 may include one or more groupings of words associated with more than one intent.

The method 800, at block B804, may include inputting the text data and the prompt data into a language model(s). For instance, the text data 104 and the prompt data 108 may be input into the language model(s) 112 of the language system 102. In some examples, the prompt model(s) 106 outputs both the text data 104 and the prompt data 108 to the language model(s) 112. In some examples, the prompt model(s) 106 outputs the prompt data 108 to the language model(s) 112 while the language system 102 also inputs the text data 104 into the language model(s) 112. As described herein, the language model(s) 112 may include a large language model(s).

The method 800, at block B806, may include determining, using the language model(s) and based at least in part on the text data and the prompt data, one or more canonical forms associated with the text. For instance, the language model(s) 112 may process the text data 502 and the prompt data 510 in order to generate the canonical form(s) 516. As described herein, a canonical form 516 may include a constrained semantic representation of the natural language of the text represented by the text data 502. For example, the canonical form 516 may be similar to the canonical form 114 generated by the language model(s) 112.

However, in some examples, to determine a canonical form, a vector(s) is determined for each word determined by the language model(s) 112. A final vector is then determined based on the vector(s), wherein the final vector corresponds to a sentence vector that represents the meaning of the sentence associated with the word(s). The final vector is then used to determine the canonical form 516, such as by finding the closest match to another vector associated with the canonical form 516.

The method 800, at block B808, may include updating one or more parameters associated with the prompt model(s) based at least in part on the one or more canonical forms and ground truth data. For instance, the training engine 516 may determine one or more errors based on the canonical form(s) 512 and the ground truth data 504. The training engine 516 may then update the parameter(s) of the prompt model(s) 106 based on the error(s). By updating the parameter(s), the prompt model(s) 106 may output prompt data 508 that causes the language model(s) 112 to more accurately determine the correct canonical form(s) 512 for an intent(s).

### Example Computing Device

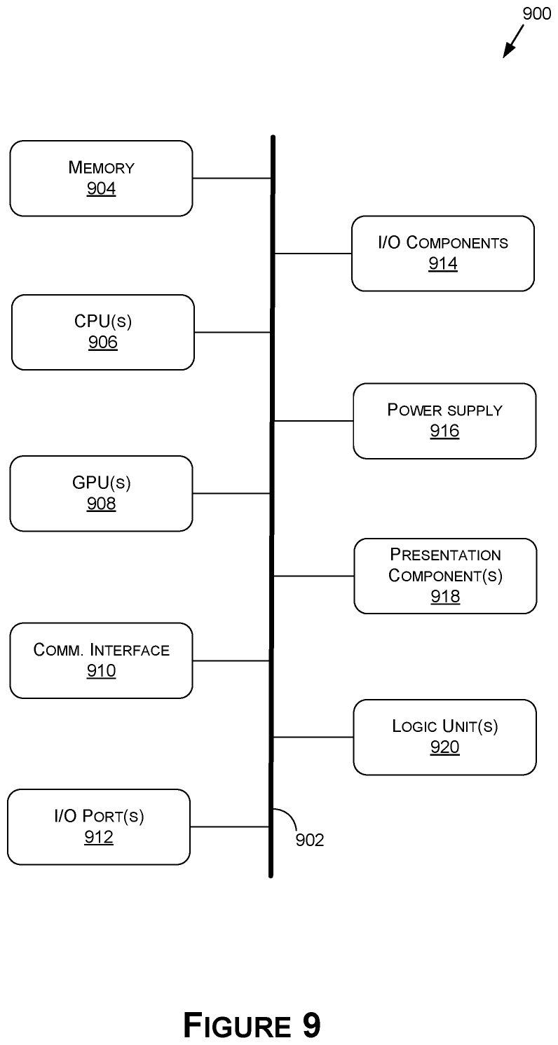

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

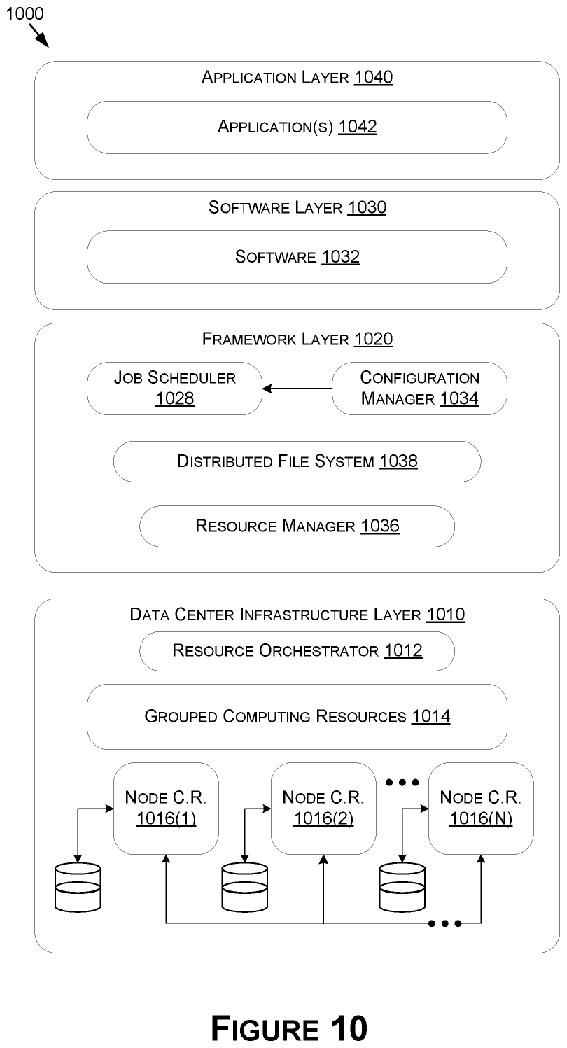

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more first models and based at least in part on text data representing text, data representing one or more prompts;
determining, using one or more second models and based at least in part on the text data and the data representing one or more prompts, a canonical form associated with the text; and
determining, based at least in part on the canonical form, at least an intent associated with the text.

2. The method of claim 1, wherein the data representing one or more prompts comprises data representing one or more vectors associated with the one or more prompts.

3. The method of claim 1, wherein the determining the canonical representation associated with the text comprises:
determining, using the one or more second models and based at least on the text data and the data representing one or more prompts, one or more vectors associated with one or more words;
determining a final vector based at least in part on the one or more vectors; and
determining that the final vector is associated with the canonical form.

4. The method of claim 3, wherein the determining that the final vector is associated with the canonical form comprises:
comparing the final vector to a set of one or more vectors, wherein at least one individual vector of the set of one or more vectors is associated with a respective canonical form associated with the text;
determining, based at least on the comparing, that the final vector is similar to a vector from the set of one or more vectors; and
determining that the vector is associated with the canonical form.

5. The method of claim 1, further comprising:
determining, based at least on at least one of the text data or the data representing one or more prompts, information associated with one or more slots for the intent; and
inputting the intent and the information associated with the one or more slots into a dialogue manager.

6. The method of claim 1, further comprising:
determining, using the one or more first models and based at least on second text data representing second text, second data representing one or more prompts, wherein the text is different from the second text; and
determining, using the one or more second models and based at least on the second text data and the second data representing one or more prompts, the canonical form is associated with the second text.

7. The method of claim 1, wherein:
the canonical form is associated with the intent; and
the one or more first models are trained to output the data representing one or more prompts that the one or more second models use to determine the canonical form associated with the intent.

8. The method of claim 1, further comprising:
determining, using the one or more first models and based at least in part on second text data representing second text, second data representing one or more prompts;
determining, using the one or more second models and based at least on the second text data and the second data representing one or more prompts, a second canonical form associated with the second text; and
updating one or more parameters associated with the one or more first models based at least in part on the second canonical form and ground truth data associated with the second text data, the ground truth data indicating that the second text data is associated with the canonical form.

9. A processor comprising:
one or more processing units to perform operations comprising:
determining, using one or more prompt models and based at least on text data representing text, prompt data representing one or more prompts;
determining, using one or more language models and based at least on the text data and the prompt data, a first canonical form associated with the text; and
updating one or more parameters associated with the one or more prompt models based at least on ground truth data associated with the text data indicating that the text corresponds to a second canonical form different from the first canonical form.

10. The processor of claim 9, wherein the updating the one or more parameters associated with the one or more prompt models comprises:
determining an error based at least on the first canonical form and the second canonical form; and
updating the one or more parameters based at least on the error.

11. The processor of claim 9, wherein the prompt data represents one or more vectors associated with the one or more prompts.

12. The processor of claim 9, wherein the determining the first canonical representation associated with the text comprises:
determining, using the one or more language models and based at least on the text data and the prompt data, one or more vectors associated with one or more words;
determining a final vector based at least on the one or more vectors; and
determining that the final vector is associated with the first canonical form.

13. The processor of claim 12, wherein the determining that the final vector is associated with the first canonical form comprises:
comparing the final vector to a set of one or more vectors, wherein at least one individual vector from the set of one or more vectors is associated with a respective canonical form;
determining, based at least on the comparing, that the final vector is similar to a vector from the set of one or more vectors; and
determining that the vector is associated with the first canonical form.

14. The processor of claim 9, wherein the operations further comprise:
determining, using the one or more prompt models and based at least on second text data representing second text, second prompt data representing one or more second prompts;
determining, using the one or more language models and based at least on the second text data and the second prompt data, a third canonical form associated with the second text; and
updating the one or more parameters associated with the one or more prompt models based at least on second ground truth data associated with the second text data indicating that the second text corresponds to the second canonical form different from the third canonical form.

15. The processor of claim 9, wherein the ground truth data for the updating the one or more parameters of the one or more prompt models corresponds to one or more outputs of the one or more language models.

16. A system comprising:
one or more processing units to:
generate, using one or more prompt models and based at least on data representing a textual input, one or more outputs;
determine, using one or more language models and based at least on the one or more outputs, a canonical representation of the textual input; and
determine, based at least on the canonical representation, an intent associated with the textual input.

17. The system of claim 16, wherein the intent is determined based at least on comparing the canonical representation to a set of one or more canonical representations associated with a set of one or more intents, and the intent corresponds to an individual canonical representation of the set of one or more canonical representation that is most similar to the canonical representation.

18. The system of claim 16, wherein the canonical representation associated with the textual input is represented using one or more first vectors, and the intent is determined based at least on comparing the one or more first vectors to one or more second vectors corresponding to one or more intents.

19. The system of claim 18, wherein ground truth data used for updating one or more parameters of the one or more prompt models during training corresponds to one or more outputs of the one or more language models during the training.

20. The system of claim 16, wherein the system is comprised in at least one of:
an infotainment system for an autonomous or semi-autonomous machine;
an entertainment system for an autonomous or semi-autonomous machine;
a system for performing simulation operations;
a system for hosting real-time streaming applications;
a system for generating content for one or more of virtual reality (VR), augmented reality (AR), or mixed reality (MR);
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
